(19) United States
(12) Patent Application Publication
(10) Pub. No.: US 2006/0038058 A1
(43) Pub. Date: Feb. 23, 2006

(54) Active control of airfoils

(76) Inventor: Edward E. Routery, Gilbert, AZ (US)

Correspondence Address: EDWARD E. ROUTERY, 1123 E BETSY LN., GILBERT, AZ, 85296, US

(21) Appl. No.: 10/925,382

(22) Filed: Aug. 23, 2004

(51) Int. Cl. B64C 27/54

(52) U.S. Cl. 244/17.13

(57) ABSTRACT

Airfoils for lifting bodies and or propulsion of aircraft, helicopters, air ships, and or ships in or on liquids, etc: A fixed spar aerodynamically and structurally designed for compromise between the minimum and maximum coefficient of friction/drag, lift, propulsion and steering.

(4). On or a part thereof in predetermined areas of airfoils, transducers (1,2,3, 1a, 2a, 3a) are affixed 1,2,3 on one side and 1a,2a,3a, on the opposite side or a part thereof. Computer programs and sensors, in cooperation with operator input, Change voltage amplitude and frequencies of specific transducers, altering the airflow, i.e. pitch of designated airfoils at any segment of 0 degrees and or rotation of 0 through 360 degrees of rotation for any required characteristic. This reduces the number and weight of parts.

### REFERENCES CITED [REFERENCED BY]

References Cited [Referenced By] U.S. Patent Documents

| | | |
|---|---|---|
| 3451644 | June, 1969 | Marchetti et al. 244/7. |
| 5409183 | April, 1995 | Gunsallus 244/17. |
| 5482383 | January, 1996 | Gantt et al. |
| 5681032 | October, 1997 | Hofmann. |
| 5741116 | April, 1998 | Hudson. |
| 5860382 | January, 1999 | Hobdy. |
| 5905212 | May, 1999 | Moses et al. |
| 5915842 | June, 1999 | Redinger. |
| 5957662 | September, 1999 | Aoki et al. |
| 5961290 | October, 1999 | Aoki et al. |
| 6135713 | October, 2000 | Domzalski et al. |
| 6168144 | January, 2001 | Bruehl. |
| 6168379 | January, 2001 | Bauer. |
| 6190132 | February, 2001 | Yamakawa et al. |
| 6200096 | March, 2001 | Kohlhepp. |
| 6224047 | May, 2001 | Gwinn. |
| 6231013 | May, 2001 | Jaenker. |
| 6231308 | May, 2001 | Kondo et al. |
| 6769872 | May, | Sikorski Aircraft Corp |

### OTHER REFERENCES

Chaffin, S R., Mark S., Application of Adjoint Optimization Method to Rotorcraft Airfoils, Presented at the American Helicopter Society Vertical Lift Aircraft Design Conference, San Francisco, Calif., American Helicopter Society, Inc. 2000.

Noonan, Kevin W., Evaluation of Mo del Helicopter Main Rotor blades With Slotted Airfoils at the Top, Presented at the American Helicopter Society 55th Annual Forum, May 25-27, 1999, Montreal, Quebec, Canada, American Helicopter Society, Inc. 1999.

Ham, Norman D., Helicopter Individual-blades-Control and Its Applications, Presented at the 39th Annual Forum of the American Helicopter Society, May 9-11, 1983, St. Louis, Mo., American Helicopter Society, Inc. 1983.

Kunze, Oliver, Arnold, Uwe T. P. & Waaske, Stefan, Development and Design of an Individual blades Control System for the Sikorsky CH-53G Helicopter, Presented at the American Helicopter Society 55th Annual Forum, May 25-27, 1999, Montreal, Quebec, Canada, American Helicopter Society, Inc. 1999.

Bernhard, Andreas P. F. & Chopra, Inderjit, Development of a Smart Moving-blades-Tip and an Active-Twist Rotor blades Driven by a Piezo-Induced Bending-Torsion Coupled Beam, Presented at the American Helicopter Society 53rd Forum, April 1997, Virginia Beach, Va., American Helicopter Society, Inc. 1997.

### BACKGROUND OF THE INVENTION

The present invention relates to active airfoils being morphed for maximum efficiency, With minimum vibration, and reduced noise, as well as improve payload and reduced overhauls. Airfoils in common use on fixed wing aircraft. Such applications, however, are either in a fixed configuration or activate at relatively slow rates. In standard applications, the aerodynamic flow environment is steady or semi-steady. Airfoil applications to rotary-wing aircraft has concentrated upon the development of fixed elements which attempt to provide a compromise between achieving an average improvement to rotor disc lift and avoiding an unacceptable increase in drag. Such fixed elements provide numerous design challenges including the aerodynamic requirements from lower-speed, high angle of attack on the retreating side of the rotor disc to high speed, low angle of attack operation on the advancing side of the rotor disc. Current designs for high lift in the low speed regime suffer from unacceptable drag levels at high speed while current designs for low drag in the high-speed regime do not show sufficient benefits of increased lift in the low speed regime.

### SUMMARY OF THE INVENTION

The present invention provides faster response times in morphing airfoils from any pitch to any other pitch or combination thereof from a 0 degree rotation airfoil to a rotational airfoils best pitch position at any portion of rotation from one degree rotation to the next degree of rotation, least parts with increased lift in the low speed regime and decreased drag levels at high speed regimes. Improved response to inputs as required for operation. Improved noise reduction and vibration. A sinusoidal or non-sinusoidal progression from one pitch to another as required.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic top view illustrating the aerodynamic environment of a helicopter main rotor in forward flight.

FIG. 2 is a plan view illustrating rotor blades according to the present invention showing preferred transducer placement patterns.

### DETAILED DESCRIPTION OF THE PREFERRED EMBODIMENT

The advantages of this invention will become apparent to those skilled in the art from the following detailed description of the currently Preferred embodiment. The drawings that accompany the detailed description can be briefly described as follows:

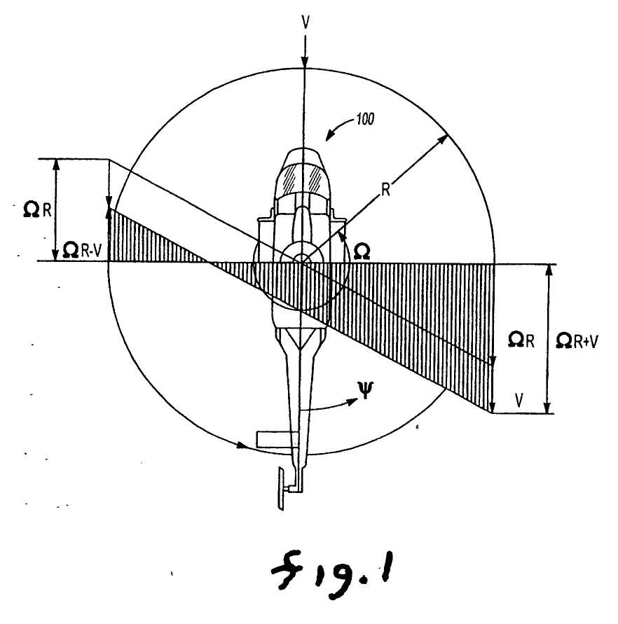

FIG. 1 generally illustrates the aerodynamic environment of a helicopter in forward flight having rotor blades. The speed of the airflow over the advancing blades tip is the rotation speed. The flight velocity. The airflow over the retreating blades tip is the rotation speed, minus the flight velocity. The airspeed difference between the advancing and the retreating blades is, relatively large.

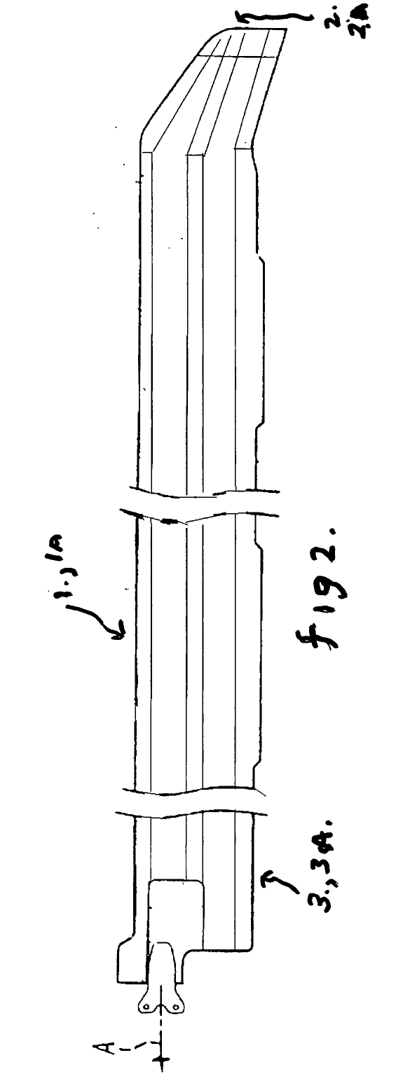

FIG. 2. As the airspeed of the advancing blade reaches its maximum, the retreating blade reaches its minimum. Each segment of rotation receives computer programmed input and or operator input providing characteristics required of said vehicle, by charging the appropriate pattern of transducers with the required voltages and frequencies to shape airfoils pitch. Each transducer is a separate entity from each other, illustrates a particular design, other designs of placement on airfoils may be beneficial for other end result uses. It should be understood that various airfoils and transducer combinations and mounting arrangements will benefit from the invention.

What is claimed is:

1. Variable rotor blades for vehicles comprising:
Airfoils having electrical transducers affixed or a part thereof, to there surfaces Varying air flow which effectively alters pitch with out mechanical actuation so as to define various azimuth angles, said azimuth angles comprising an advancing angle between 0 and 180 degrees in one degree segments from direction of flight and a retreating angle between 180 and 360 degrees from direction of flight in one degree segments; said blades receive pitch input electrically to the main blades.

2. The rotor blades as recited in claim 1, further comprising a electrical controller operable to charge each transducer in accordance with programmed motion.

3. The rotor blades as recited in claim 1, further comprising a controller operable to actively vary the intensity and frequency in response to a sensed parameter.

4. The rotor blades as recited in claim 1, wherein said transducers change independently relative to each other without relating movement of one transducer to another to reduce drag and increase lift of the

5. A method of controlling an airfoils pitch, the pitch having a base position minimum load, said method comprising the steps of:
(1) Charging the transducers to define pitch at any azimuth angle, said azimuth angle comprising angles between 0 and 360 degrees.

6. a method as recited in claim 1, wherein said step (2) further comprises:
Controlling the pitch in accordance with a prescribed motion schedule.

7. a method as recited in claim 1, wherein said step (2) further comprises:
Modifying said prescribed motion schedule in response to a flight condition.

8. a method as recited in claim 1, wherein said step (2) further comprises:
Actively controlling the pitch in response to a sensed parameter.

9. A method as recited in claim 18, wherein said step (1) further comprises:
independently changing the pitch of one blade without relating movement of the pitch to other then the proscribed second blade to reduce drag and increase lift of the airfoil.

10. a method as recited in claim 1, Airfoils for a vehicle comprising:
Transducers charged to vary airflow providing pitch to define an azimuth angle, said azimuth angle comprising an advancing angle between 0 and 180 degrees and a retreating angle between 180 and 360 degrees.
